(19) United States
(12) Patent Application Publication
(10) Pub. No.: US 2025/0292166 A1
(43) Pub. Date: Sep. 18, 2025

(54) Technologies for Matching Procurement Opportunities With Capabilities of Contract Seekers

(71) Applicant: Illinois Hispanic Chamber of Commerce Foundation, Chicago, IL (US)

(72) Inventor: Adrián Rodríguez, Chicago, IL (US)

(21) Appl. No.: 19/073,245

(22) Filed: Mar. 7, 2025

Related U.S. Application Data
(60) Provisional application No. 63/564,069, filed on Mar. 12, 2024.

(51) Int. Cl. G06Q 10/0631; G06F 16/953

(52) U.S. Cl. CPC G06Q 10/063112; G06F 16/953

(57) ABSTRACT

A computerized system and method are provided that match capabilities of contract seekers with procurement opportunities. One or more scraping bots scrape a plurality of websites to extract request for proposal (RFP) data representing a plurality of procurement opportunities, and this RFP data is stored in a scraped contract database. In response to receiving a procurement opportunity search request from a contract seeker associated with a capabilities statement, a closeness score is determined between the contract seeker's capabilities statement and the plurality of procurement opportunities in the scraped contract database based on similarities therebetween. The plurality of procurement opportunities in the scraped contract database are ranked as a function of the determined closeness score.

### RELATED APPLICATIONS

This application claims the benefit of U.S. Provisional Application Ser. No. 63/564,069 filed Mar. 12, 2024 for “Technologies for Matching Procurement Opportunities With Capabilities of Contract Seeker,” which is hereby incorporated by reference in its entirety.

### TECHNICAL FIELD

This system relates generally to a computerized system of matching procurement opportunities with contract seeker capabilities; in particular, this system relates to a machine learning system that matches requests for proposals (RFPs) with capabilities of contract seekers.

### BACKGROUND

Government procurement is a notoriously complex process. Private firms that wish to undertake public projects are not only expected to file mountains of paperwork, but also need to submit extensive proposals. Public procurement is a painfully fragmented landscape where every public entity has its own rules, processes and requirements, causing firms to duplicate work in order to apply for several contracts. The result is that public procurement is a large company's game. Smaller firms simply do not have the resources and the know-how, especially minority firms, who are often newer to the system and have to simultaneously navigate language barriers and discrimination.

The support small business owners need when they decide to bid on government or corporate contracts work is not being met by the available resources. Although small business owners may be experts in their respective fields of work and operations, they often underestimate the time and resources to comply with all the documentation required with these contracts. Many of these owners are “solopreneurs,” constantly juggling the role of CEO, COO, and CFO to the receptionist.

When it comes to the required office operations/management capacity to meet the demands of government contracting, a majority are at a loss. Unfortunately, many programs available focus their assistance on certification, giving these owners the impression that certification equals contract opportunities, but this cannot be further from the truth. Although vital to the process, certification is probably the easiest hurdle relative to the bidding and contracting obligations. More focus needs to be given to the documentation required when bidding on contracts, from estimates to basic submittals and everything in between.

Moreover, knowledge and know-how are not enough to get things done. There is a need for practical aspects in the form of tools of procurement and connection opportunities.

### BRIEF DESCRIPTION OF THE DRAWINGS

The present disclosure will be described hereafter with reference to the attached drawings which are given as non-limiting examples only, in which:

FIG. 1 is simplified block diagram of a system for finding procurement opportunities according to an embodiment of the present disclosure;

FIG. 2 is a simplified block diagram of at least one embodiment of a computing device for finding procurement opportunities according to an embodiment of this disclosure;

FIG. 3 is a simplified block diagram of an example scraping subsystem according to an embodiment of the present disclosure;

FIG. 4 is a simplified block diagram of an example contract seeking subsystem according to an embodiment of the present disclosure;

FIG. 5 is a simplified block diagram of an example contract matching subsystem according to an embodiment of the present disclosure;

FIG. 6 is a simplified flow diagram illustrating an example ranking of RFPs from scraped procurement opportunities; and

FIG. 7 is a simplified flow diagram of at least one embodiment illustrating steps that may be taken by the system for finding procurement opportunities.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

In some embodiments, this disclosure relates to a system that collects data on procurement opportunities, such as government and private request for proposals (RFPs), through data scraping over the Internet. The system analyzes this procurement opportunity data based on capability statements of contract seekers to determine the top contract opportunities available from the scraped data. In some cases, the system uses machine learning techniques to determine which procurement opportunities most closely match capability statements of contract seekers. By way of example, the system may use term frequency-inverse document frequency (TF-IDF) and/or cosine distance algorithms to generate a score or distance between capability statement of contract seekers and procurement opportunities. In some embodiments, the system may be configured to send alerts to contract seekers when new opportunity data is scraped that has a threshold score or distance to the capability statement of the contract seeker. The system, in some embodiments, could generate at least a portion of a proposal based on the scraped data and information about the contract seeker, such as the capability statement. In some embodiments, this system overcomes the technical problem of seeking procurement opportunity data that matches with a capability statement of a contract seeker by using machine learning techniques, such as TF-IDF and/or cosine distance algorithms, to determine a closeness score between a procurement opportunity and a capability statement. In some cases, the system also addresses a technical problem of speed in alerting contract seekers to new opportunities; in some embodiments, alerts could be automatically be sent based on newly scraped data that has a threshold closeness to the capability statement of a contract seeker.

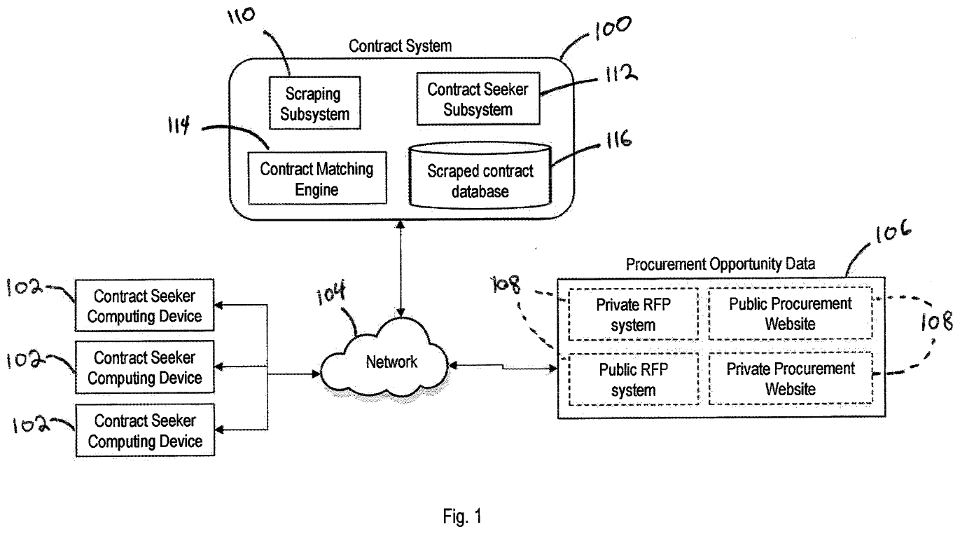

FIG. 1 illustrates an embodiment of the system 100 in which a plurality of contract seeker computing devices 102 are able to access the system 100 over a network 104 to find matches to procurement opportunities 106. In some embodiments, the system 100 scrapes data, such as contract information about requests for proposal (RFPs) from private and public contract systems 108. The system 100 is configured to determine which procurement opportunities 106 best match with capabilities of contract seekers as discussed herein.

In the embodiment shown, the system 100 includes a scraping subsystem 110, a contract seeker subsystem 112, a contract matching engine 114, and a scraped contract database 116. For example, as explained herein, the scraping subsystem 110 may be configured to collect data regarding a multiplicity of procurement opportunities, such as public and/or private RFPs, by scraping data from, among other possible data sources, contract and RFP systems 108 available on the Internet and/or other network(s) accessible to the system 100. The contract seeker subsystem 112 is configured to allow a contract seeker to build a capability statement, which describes one or more capabilities of the contract seeker. The contract matching engine 114 is configured to determine a closeness score between opportunities in the scraped contract database 116 and the capability statement. This allows the system 100 to rank opportunities for the contract seeker. For example, the contract seeker may use the system 100 to search for current opportunities that are closest to its capability statement, and these opportunities could be ranked based on the closeness score. In some cases, the system 100 may set a threshold closeness score for triggering an alert to the contract seeker, which provides ongoing communications regarding potential opportunities that are close to the contract seeker's capabilities. Depending on the circumstances, the threshold closeness score could be adjusted by the contract seeker.

Although the example in FIG. 1 shows three contract seeker computing devices 102 for purposes of simplicity, there could be thousands or millions (or more) of such devices using the system 100. In some embodiments, the devices 102 may be mobile devices running the Android™ operating system by Google, Inc. of Mountain View, California or a device running iOS™ operating system by Apple Inc. of Cupertino, California on which software has been installed to run one or more features according to an embodiment of the present disclosure. For example, the devices 102 may have an app installed that allows a contract seeker to search for procurement opportunities and/or perform other actions described herein. In some embodiments, the system 100 could be a website from which contract seekers could access the features described herein through a web browser, such as Google Chrome™. In some cases, the system 100 could be a system as a service (SaaS) that is accessible through the network 104 via a website portal and/or mobile app. Even though a single system 100, which could be a server, is shown for purposes of simplicity, there could be more than one server. For example, it should be appreciated that various subsystems (or portions of subsystems) of the server may operate on different computing devices. By way of example, the system 100 could be housed in a data center on one or more servers and accessed from the computing devices 102.

As shown, the various components of the system may be embodied as hardware, firmware, software, or a combination thereof. As such, in some embodiments, one or more of the components of the system 100 may be embodied as circuitry or collection of electrical devices (e.g., scraping subsystem circuitry, contract seeker subsystem circuitry, contract matching engine circuitry, and scraped contract database circuitry). In the illustrative embodiment, the scraping subsystem circuitry, contract seeker subsystem circuitry, contract matching engine circuitry, and scraped contract database circuitry are embodied as hardware, firmware, or other resources of the system 100. Additionally or alternatively, in some embodiments, those components may be embodied as hardware, firmware, or other resources of the computing device 102. Additionally, in some embodiments, one or more of the illustrative components may form a portion of another component and/or one or more of the illustrative components may be independent of one another.

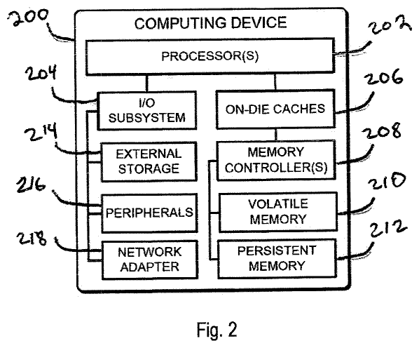

Referring now to FIG. 2, an illustrative computing device 200 for finding procurement opportunities, such as public and/or private RFP opportunities that best match capabilities of the contract seeker. For example, the system 100 and/or contract seeker computing devices 102 may be embodied as the computing device 200. As shown, the computing device 200 includes at least one processor 202, an I/O subsystem 204, at least one on-die cache 206, and a memory controller 208 to control a volatile memory 210 and a persistent memory 212. The computing device 200 may be embodied as any type of device capable of performing the functions described herein. For example, the computing device 200 may be embodied as, without limitation, a computer, a workstation, a server computer, a laptop computer, a notebook computer, a tablet computer, a smartphone, a mobile computing device, a desktop computer, a distributed computing system, a multiprocessor system, a consumer electronic device, a smart appliance, and/or any other computing device capable of executing software code segments. As shown in FIG. 2, the illustrative computing device 200 includes the processor 202, the I/O subsystem 204, the on-die cache 206, and the memory controller 208 to control volatile memory 210 and persistent memory 212. Of course, the computing device 200 may include other or additional components, such as those commonly found in a workstation (e.g., various input/output devices), in other embodiments. For example, the computing device 200 may include an external storage 214, peripherals 216, and/or a network adapter 218. Additionally, in some embodiments, one or more of the illustrative components may be incorporated in, or otherwise form a portion of, another component. For example, the memory 210, 212 or portions thereof, may be incorporated in the processor 202 in some embodiments.

The processor 202 may be embodied as any type of processor capable of performing the functions described herein. For example, the processor may be embodied as a single or multi-core processor(s), digital signal processor, microcontroller, or other processor or processing/controlling circuit. The volatile memory 210 and persistent memory 212 may be embodied as any type of volatile memory and persistent memory, respectively, capable of performing the functions described herein. Volatile memory 210 contrasts with persistent memory 212 in that the persistent memory 212 does not lose content when power is lost. In operation, the volatile memory 210 and persistent member 212 may store various data and software used during operation of the computing device 200 such as operating systems, applications, programs, libraries, and drivers. The memory 210, 212 is communicatively coupled to the processor 202 via the memory bus using memory control(s) 208, which may be embodied as circuitry and/or components to facilitate input/output operations with the processor 202, the memory 210, 212, and other components of the computing device 200.

The I/O subsystem 204 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processor 202, the memory 210, 212, and other components of the computing device 200, on a single integrated circuit chip.

An external storage device 214 may be coupled to the processor 202 with the I/O subsystem 204. The external storage device 214 may be embodied as any type of device or devices configured for short-term or long-term storage of data such as, for example, memory devices and circuits, memory cards, hard disk drives, solid-state drives, or other data storage devices.

The computing device 200 may also include peripherals 216. The peripherals 216 may include any number of additional input/output devices, interface devices, and/or other peripheral devices. By way of example only, the peripheral 216 may include a display that could be embodied as any type of display capable of displaying digital information such as a liquid crystal display (LCD), a light emitting diode (LED), a plasma display, a cathode ray tube (CRT), or other type of display device.

The computing device 200 illustratively includes a network adapter 218, which may be embodied as any communication circuit, device, or collection thereof, capable of enabling communications between the computing device 200 and other remote devices over a computer network 104. The network adapter 218 may be configured to use any one or more communication technology (e.g., wired or wireless communications) and associated protocols (e.g., Ethernet, Bluetooth®, Wi-Fi®, WiMAX, cellular, etc.) to effect such communication.

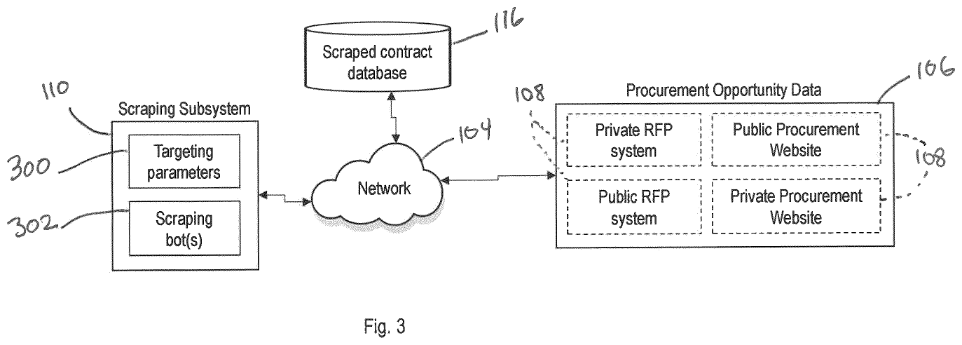

FIG. 3 depicts an exemplary diagrammatic view of the scraping subsystem 110. In the embodiment shown, the scraping subsystem 110 includes one or more targeting parameters 300 and one or more scraping bot(s) 302. In some embodiments, the scraping subsystem 110 may be configured with one or more targeting parameters 300, which could be a variety of different types of data that configure where, how, and/or when to scrap data. For example, a targeting parameter could be a URL of a known data source (e.g., website) that contains information about RFPs.

As shown, the scraping subsystem 110 includes one or more scraping bots 302 that are programmed to scan through multiple data sources available on the Internet (or other network(s) to which the system 100 has access). The scraping bots 302 download or “scrape” content from the websites (or other data sources) regarding procurement opportunities and saves this data in the scraped contract database 116. In this manner, data regarding a multiplicity of procurement opportunities can be “scraped” throughout the Internet and stored in the scraped contract database 116. In some embodiments, the scraping bots 302 may periodically or substantially continuously scrape data regarding RFPs and/or other procurement opportunities so that the scraped contract database 116 is updated with current opportunity data.

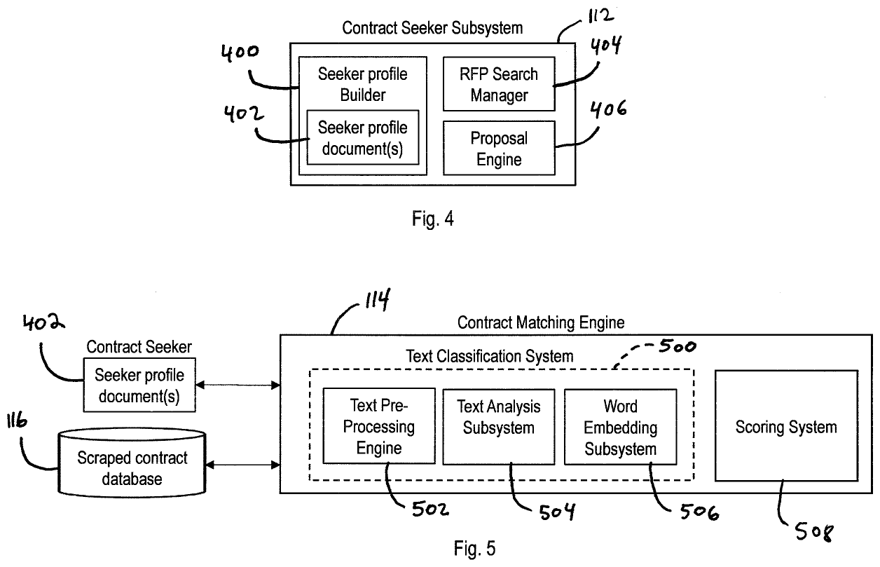

FIG. 4 depicts an exemplary diagrammatic view of the contract seeker subsystem 112. In the embodiment shown, the contract seeker subsystem 112 includes a seeker profile builder 400, which may include one or more seeker profile documents 402 that describe the contract seeker's capabilities. The seeker profile builder 400 is configured to receive data regarding a contract seeker. For example, the seeker profile builder 400 may include a user interface for inputting information about a contract seeker, which is stored in the system 100. By way of example, the name and mailing address of the contract seeker could be stored in the system 100. In some embodiments, the seeker profile builder 400 may include an import function to batch store information about the contract seeker in the system 100. For example, the seeker profile builder 400 may import a description of services from the contract seeker's website and/or advertising materials. In some cases, one or more capabilities statements can be entered via the contract seeker subsystem 112, which describe the services provided by the contract seeker. By way of example, the capabilities statement(s) may be one or more documents with a description of some or all the services that the contract seeker is capable of providing. As discussed herein, the words and/or concepts from the capabilities statements may be matched with the procurement opportunities in the scraped RFPs to determine which are most similar to each other. In this manner, the contract seeker can search for the RFPs that most closely match the services that the contract seeker provides.

In some embodiments, the contract seeker subsystem 112 includes a RFP search manager 404, which is configured to allow a contract seeker to search for the procurement opportunities that most closely match its capabilities statement 402 based on the contract matching engine 114. By way of example only, the contract seeker could search for the top X number of procurement opportunities and the RFP search manager 404 will return the X procurement opportunities that most closely match the contract seeker's capabilities based on the results of the contract matching subsystem 114. In some embodiments, the RFP search manager 404 could include an automated alert feature that automatically communicates procurement opportunities to respective contract seekers based on updates to the scraped contract database 116 and closeness of newly scraped procurement data to respective contract seekers' capabilities statements. This allows contract seekers to be alerted to new procurement opportunities substantially in real time when newly scraped procurement data is added to the scraped contract database 116.

In some embodiments, the contract seeker subsystem 112 includes a proposal engine 406. For example, the proposal engine 406 could take information about a contract seeker, such as the seeker profile document(s) 402 and populate a template proposal with this information. In some cases, information regarding the RFP could also be used to populate the template proposal.

Referring to FIG. 5, in some embodiments, the system 100 includes a contract matching engine 114 that is configured to find the RFPs from the scraped contract database 116 that most closely matches the contract seeker's capabilities statement from the seeker profile document(s) 402. In the embodiment shown, the contract matching engine 114 includes a text classification system 500 that can determine closeness between the contract seeker's capabilities statement and the RFPs from the scraped contract database 116. As shown, the text classification system 500 includes a text preprocessing engine 502, a text analysis subsystem 504, and a word embedding subsystem 506.

In some cases, the text preprocessing engine 502 may perform one or more pre-processing steps on the scraped contract data 116 and/or the seeker profile document(s) 402. For example, the text preprocessing engine 502 may perform text cleansing, such as removing stop words (e.g., words that are non-informative, such as “are”). The text preprocessing engine 502 may perform tokenization on the scraped contract data 116 and/or the seeker profile document(s) 402, such as splitting documents into words. In some cases, the text preprocessing engine 502 may perform lemmatization, such as transforming words with the same root (e.g., healthy, healthiest, health→health).

The text analysis subsystem 504 may be configured to perform term frequency-inverse document frequency (TF-IDF) analysis on scraped contract data 116 and/or the seeker profile document(s) 402. The TF-IDF analysis allows the text analysis subsystem 504 to determine a measure of importance of words in a document. The term frequency (TF) is a measure of the relative frequency of a term t within a document d. The inverse document frequency (IDF) is a measure of how much information the word provides, such as whether the word is common or rare across all documents. For example, tf(t,d)·idf(t, [symbol] )=tf(t,d)·idf(t, [symbol] ), such that:

$$tf ( t , d ) = \frac{{f}_{t , d}}{{\sum }_{t ∈ d} {f}_{t , d}} ,$$

where f_{t,d} is the number of times word d appears in document and Σ_{t∈d}f_{t,d} is the total number of words in document t. Regarding IDF,

$$idf ( t , D ) = log \frac{N}{\vert \{ d ∈ D : t ∈ d \} \vert}$$

where N=the total number of document in corpus and |{d∈ [symbol] :t∈d}| is the number of documents with the word d.

The word embedding subsystem 506 is configured to perform word embedding, and in some cases, sentence embedding on scraped contract data 116 and/or the seeker profile document(s) 402. For example, the word embedding subsystem 506 may be used to obtain vector representations of words, sentences, and documents, and compare the similarities between two texts. By way of example only, an open-source natural language processing (NLP) library called spaCy by ExplosionAI GmbH of Berlin, Germany could be used for the word embedding subsystem 506. The word embedding subsystem 506 may include NLP models that can be trained with many texts from different sources. Once the similarities between the seeker profile documents with the capabilities statement(s) 402 and the RFPs from the scraped contract database 116 are determined, a scoring system 508 ranks the RFPs based on similarities with the capabilities statement(s) in the seeker profile document(s) 402 so that the job seeker can see which RFPs most closely match its capabilities.

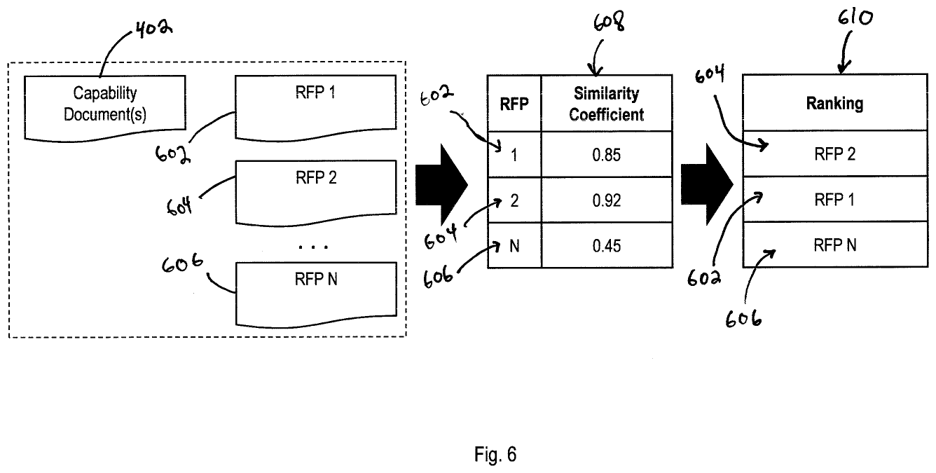

FIG. 6 illustrates an example analysis that could be performed by the text classification system 500 and the scoring system 508. In this example, there is one or more capability statements in the seeker profile document(s) 402, which could be one or more documents describing services provided by a contract seeker. As shown, there are a plurality of procurement opportunities that are in the scraped contract database 116, which are labeled as RFP 1 602, RFP 2 604, and RFP N 606. The text classification system 500 is configured to generate a similarity coefficient 608 based on the similarity of words and/or concepts between the contract seeker's capabilities statement 402 and the procurement opportunities RFP 1 602, RFP 2 604, and RFP N 606. In the example shown, RFP 1 602 has a similarity coefficient of 0.85, RFP 2 604 has a similarity coefficient of 0.92, and RFP N 604 has a similarity coefficient of 0.45. The scoring system 508 is able to generate a ranking 610 of the RFPs based on the similarity coefficients. In this example, RFP 2 604 is ranked first with the highest similarity coefficient, RFP 1 602 is ranked second with the second highest similarity coefficient, and RFP N 604 is ranked last with the lowest similarity coefficient.

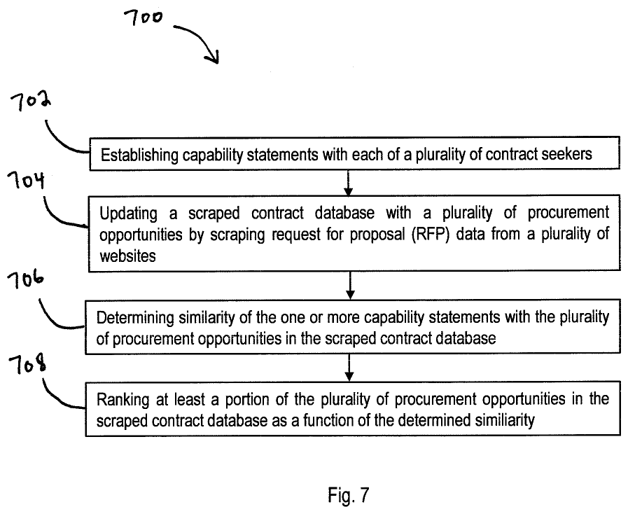

FIG. 7 illustrates a method 700 for matching contract seeker capabilities with procurement opportunities in the scraped contract database 116 by the system 100. It should be appreciated that, in some embodiments, the operations of the method 700 may be performed by one or more components of the system 100 and/or computing device(s) 102 as shown in FIG. 1, such as the contract seeker subsystem 112 and/or contract matching engine 114. Also, it should be appreciated that the order of steps for the method 700 shown in FIG. 7 are for purposes of example, and could be in a different order; likewise, depending on the circumstances, some steps shown in the method 700 may be optional, or may not always be performed.

As illustrated, the method 700 begins at block 702 in which a capability statements is established for each of the contract seekers. For example, the capability statements in the seeker profile document(s) 402 could be input with the seeker profile builder 400 of the contract seeker subsystem 112 or imported from an external data source. The method 700 includes the block 704 of scraping one or more websites (or other data sources) and downloading the data in the scraped contract database 116. The method 700 advances to block 706 in which the contract matching subsystem 114 determines closeness of procurement opportunities in the scraped contract database 116 and capability statement(s) 402 of a contract seeker. For example, in some embodiments, the contract matching subsystem 114 may use the text classification system 500 to determine the closest matches. Next, the method 700 goes to block 708 in which the procurement opportunities are ranked by the scoring system 508 based on closeness. As discussed herein, this allows the contract seeker to determine which RFPs most closely match the services provided and/or offered by the contract seeker.

1. A computer-implemented method to match capabilities of contract seekers with procurement opportunities, the method comprising:
scraping a plurality of websites with one or more scraping bots to extract request for proposal (RFP) data representing a plurality of procurement opportunities;
storing the RFP data extracted by the one or more scraping bots in a scraped contract database;
receiving a procurement opportunity search request from a contract seeker associated with a capabilities statement;
determining a closeness score between the capabilities statement of the contract seeker and the plurality of procurement opportunities in the scraped contract database based on similarities therebetween; and
ranking at least a portion of the plurality of procurement opportunities in the scraped contract database as a function of the determined closeness score.

2. The method of claim 1, wherein determining the closeness score includes generating respective similarity coefficients for at least a portion of the plurality of procurement opportunities in the scraped contract database, wherein each of the similarity coefficients indicate similarity of words and/or concepts between the contract seeker's capabilities statement and a procurement opportunity in the scraped contract database.

3. The method of claim 2, wherein ranking the plurality of procurement opportunities comprises ordering the plurality of procurement opportunities as a function of respective similarity coefficients.

4. The method of claim 1, wherein determining the closeness score is based on one or more of a term frequency-inverse document frequency algorithm and/or a cosine distance algorithm.

5. The method of claim 4, wherein determining the closeness score includes performing text preprocessing to tokenize the RFP data and/or the capabilities statement of the contract seeker.

6. The method of claim 5, wherein determining the closeness score includes performing word embedding with one or more natural language processing (NLP) models on the RFP data and/or the capabilities statement of the contract seeker.

7. The method of claim 1, further comprising periodically determining closeness scores for one or more procurement opportunities in newly scraped RFP data based on the contract seeker's capability statement and generating an alert to the contract seeker identifying one more procurement opportunities exceeding a threshold closeness score.

8. The method of claim 7, wherein the threshold closeness score is user-adjustable.

9. The method of claim 1, wherein the capabilities statement indicates one or more services provided by the contract seeker.

10. The method of claim 9, further comprising extracting the capabilities statement from the contract seeker's website and/or advertising materials.

11. A system to match capabilities of contract seekers with procurement opportunities, the system comprising:
circuitry configured to:
scrape a plurality of websites with one or more scraping bots to extract request for proposal (RFP) data representing a plurality of procurement opportunities;
store the RFP data extracted by the one or more scraping bots in a scraped contract database;
receive a procurement opportunity search request from a contract seeker associated with a capabilities statement;
determine a closeness score between the capabilities statement of the contract seeker and the plurality of procurement opportunities in the scraped contract database based on similarities therebetween; and
rank at least a portion of the plurality of procurement opportunities in the scraped contract database as a function of the determined closeness score.

12. The system of claim 11, wherein to determine the closeness score includes generating respective similarity coefficients for at least a portion of the plurality of procurement opportunities in the scraped contract database, wherein each of the similarity coefficients indicate similarity of words and/or concepts between the contract seeker's capabilities statement and a procurement opportunity in the scraped contract database.

13. The method of claim 12, wherein to rank the plurality of procurement opportunities comprises ordering the plurality of procurement opportunities as a function of respective similarity coefficients.

14. The method of claim 11, wherein to determine the closeness score is based on one or more of a term frequency-inverse document frequency algorithm and/or a cosine distance algorithm.

15. The method of claim 14, wherein to determine the closeness score includes performing text preprocessing to tokenize the RFP data and/or the capabilities statement of the contract seeker.

16. The method of claim 15, wherein to determine the closeness score includes performing word embedding with one or more natural language processing (NLP) models on the RFP data and/or the capabilities statement of the contract seeker.

17. The method of claim 11, further comprising circuitry to periodically determine closeness scores for one or more procurement opportunities in newly scraped RFP data based on the contract seeker's capability statement and generate an alert to the contract seeker identifying one more procurement opportunities exceeding a threshold closeness score.

18. The method of claim 17, wherein the threshold closeness score is user-adjustable.

19. The method of claim 11, wherein the capabilities statement indicates one or more services provided by the contract seeker.

20. The method of claim 19, further comprising circuitry to extract the capabilities statement from the contract seeker's website and/or advertising materials.
